(19) United States
(12) Patent Application Publication
(10) Pub. No.: US 2022/0271342 A1
(43) Pub. Date: Aug. 25, 2022

(54) BATTERIES AND ELECTRICAL DEVICES

(71) Applicant: NINGDE AMPEREX TECHNOLOGY LIMITED., Ningde City (CN)

(72) Inventor: Yueting DUAN, Ningde City (CN)

(21) Appl. No.: 17/743,306

(22) Filed: May 12, 2022

Related U.S. Application Data
(63) Continuation of application No. PCT/CN2019/120327, filed on Nov. 22, 2019.

(51) Int. Cl. H01M 10/0583; H01M 50/538; H01M 50/536; H01M 4/134

(52) U.S. Cl. CPC H01M 10/0583; H01M 50/538; H01M 50/536; H01M 4/134

(57) ABSTRACT

A battery includes a winding unit formed by winding a negative electrode piece and a positive electrode piece together. The negative electrode piece includes a negative electrode current collector and a negative electrode active layer provided on the negative electrode current collector. The negative electrode active layer includes a silicon negative electrode material. The battery further includes tabs. The tabs are welded to the negative electrode current collector. Among them, the capacity per gram C of the silicon negative electrode material, the welding strength a of the tabs in the initial battery, and the welding strength b of the tabs in the battery after 300 cycles have the following relationship:
when 400 mAh/g<C≤600 mAh/g, 50%<b/a<65%;
when 600 mAh/g<C≤800 mAh/g, 65%<b/a<80%;
when 800 mAh/g<C≤1000 mAh/g, 80%<b/a<90%; and
when C>1000 mAh/g, b/a>90%.

### CROSS-REFERENCE TO RELATED APPLICATIONS

This present application is a continuation of PCT/CN2019/120327, filed on Nov. 22, 2019, entitled “BATTERY AND ELECTRICAL DEVICE”, the disclosure of which is incorporated herein by reference in its entirety.

### TECHNICAL FIELD

The present application relates to batteries and electrical devices comprising the same.

BACKGROUND

In recent years, with the rapid development of 3C business and the integration requirements of 3C products, higher requirements have been placed on the volumetric energy density of batteries, In order to make batteries meet higher volumetric energy density requirements, the current pure graphite negative electrode system can no longer be satisfied. In addition, silicon-based materials are considered to be the most possible negative electrode materials for large-scale applications in lithium batteries due to the reversible capacity of silicon as high as 4200 rnAh/g so as to continue to improve the volumetric energy density of batteries. However, after multiple charge-discharge cycles, silicon-based materials undergo huge volume changes with the intercalation and deintercalation of lithium ions, and the volume expansion rate can even reach 300%, resulting in huge mechanical stress. Among them, in addition to causing the pole piece to expand in the thickness direction, the mechanical stress also includes significant lateral expansion. In addition, the mechanical stress also easily leads to the wrinkle deformation of the pole piece during the cycle, and the wrinkle deformation of the pole piece can cause tearing of the welding part in the tab. As the folds and deformations of the pole pieces become more serious during the cycle, it will cause the welding part of the tabs to be de-soldered, and thus lead to the inability of the battery to transmit electrons during the charging and discharging process, and eventually lead to the failure of the entire battery.

### SUMMARY

In view of this, it is necessary to provide a battery that can solve the problem of the tab de-soldering in the battery after multiple cycles.

The present application also provides an electrical device comprising the battery.

A battery, comprising a winding unit formed by winding a negative electrode piece and a positive electrode piece together. The negative electrode piece comprises a negative electrode current collector and a negative electrode active layer provided on the negative electrode current collector, the negative electrode active layer includes silicon negative electrode material. The battery further comprises:

a tab that is welded to the negative electrode current collector, wherein the capacity per gram C of the silicon negative electrode material, the welding strength a of the tab in the initial battery and the welding strength b of the tab in the battery after 300 cycles have the following relationship:

$$when 400 mAh / g < C \leq 600 mAh / g , 50 \% < b / a < 65 \% ; \\ when 600 mAh / g < C \leq 800 mAh / g , 65 \% < b / a < 80 \% ; \\ when 800 mAh / g < C \leq 1000 mAh / g , 80 \% < b / a < 90 \% ; and \\ when C > 1000 mAh / g , T \times f = b / a > 90 \% .$$

In some embodiments, the silicon negative electrode material comprises at least one of silicon element, silicon compound, and silicon alloy:

In some embodiments, the welding strength of the tab is tested by using a horizontal tensile machine, and the horizontal tensile machine has a tensile rate of 1 mm/s.

In some embodiments, the welding strength of the tab in the initial battery is 18.7 N/m to 41.6 N/m.

In some embodiments, the tabs are welded to the negative electrode current collector by an ultrasonic welding device, and the ultrasonic welding device comprises a welding seat and a welding head, wherein the welding head and the welding seat need to be heated before welding.

in some embodiments, the single-sided coating mass of the silicon negative electrode material on the negative electrode current collector is 10 g/m2 to 85 g/m2.

In some embodiments, the temperature of the welding head, the vibration frequency f of the welding head and the capacity per gram C of the silicon negative electrode material have the following relationship:

$$when 400 mAh / g < C \leq 600 mAh / g , T \times f = 2 \sim 5.5 \times C .$$

In some embodiments, the temperature T of the welding head, the vibration frequency f of the welding head and the capacity per gram C of the silicon negative electrode material have the following relationship:

$$when 600 mAh / g < C \leq 800 mAh / g , T \times f = 6 \sim 10.8 \times C .$$

In some embodiments, the temperature T of the welding head, the vibration frequency f of the welding head and the capacity per gram C of the silicon negative electrode material have the following relationship:

$$when 800 mAh / g < C \leq 1000 mAh / g , T \times f = 11.5 \sim 14.5 \times C .$$

In some embodiments, the temperature I of the welding head, the vibration frequency f of the welding head and the capacity per gram C of the silicon negative electrode material have the following relationship:

$$when C > 1000 mAh / g , T \times f = 15 \sim 20.8 \times C .$$

An electrical device, comprising the battery described above.

The battery in the application defines the welding strength ratio of the tabs in the battery after 300 cycles according to the capacity per gram C of different silicon negative electrode materials, so as to effectively avoid the problem of the tabs' de-soldering caused by the wrinkle and deformation of the negative electrode piece due to the expansion and contraction of the silicon negative electrode material during the charging and discharging process of the battery, thereby ensuring the normal transmission of electrons during the charging and discharging process of the battery.

### BRIEF DESCRIPTION OF THE DRAWINGS

FIG. 1 is a schematic diagram of a battery according to an embodiment of the application.

FIG. 2 is a schematic cross-sectional view of the negative electrode piece as shown in FIG. 1.

FIG. 3 is a schematic block diagram of an ultrasonic welding device according to an embodiment of the application.

FIG. 4 is a schematic cross-sectional view of the positive electrode piece as shown in FIG. 2.

FIG. 5 is a flowchart of a method for manufacturing a battery according to an embodiment of the application.

FIG. 6 is a schematic diagram of an electrical device according to an embodiment of the application.

### DESCRIPTION OF MAIN ELEMENT SYMBOLS

Cell 100

Winding unit 10

Negative pole piece 11

Negative electrode current collector 111

Negative electrode active layer 112

Positive pole piece 12

Positive electrode current collector 121

Positive electrode active layer 122

Separator 13

Tab 20

Housing 30

Ultrasonic welding device 200

Welding seat 201

Welding head 202

Electrical device 300

The following specific embodiments will further illustrate the present application in conjunction with the above-mentioned drawings.

### DETAILED DESCRIPTION

The technical solutions in the embodiments of the present application will be clearly and completely described below with reference to the drawings in the embodiments of the present application. Obviously, the described embodiments are only a part but not all of the embodiments of the present application. Based on the embodiments in this application, those skilled in the art would obtain all the other embodiments without creative efforts, which falls within the scope of this application.

Unless otherwise defined, all technical and scientific terms used herein have the same meanings as commonly understood by those skilled in the technical field to which this application belongs. The terms used herein in the specification of the application are merely for the purpose of describing specific embodiments, and are not intended to limit the application.

Some embodiments of the present application will be described in detail below with reference to the accompanying drawings. The embodiments described below and features in the embodiments may be combined with each other without conflict.

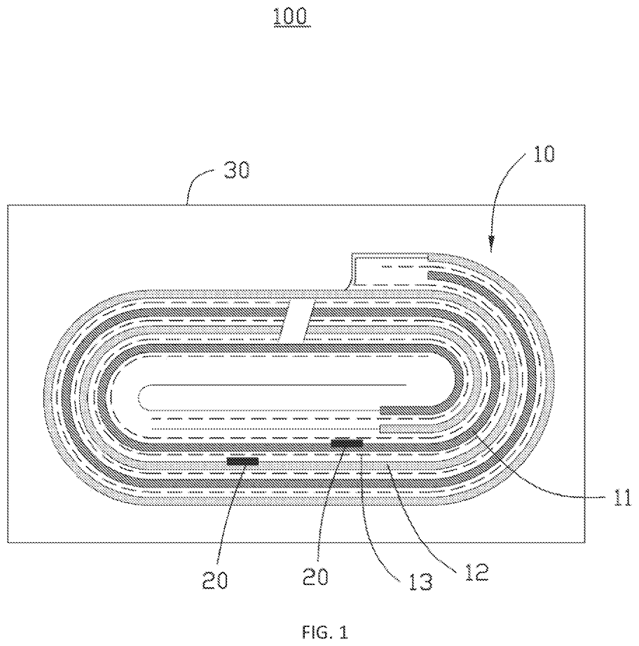

Referring to FIG. 1, an embodiment of the present application provides a battery 100. The battery 100 comprises a winding unit 10 formed by winding the negative electrode piece 11 and the positive electrode piece 12 together.

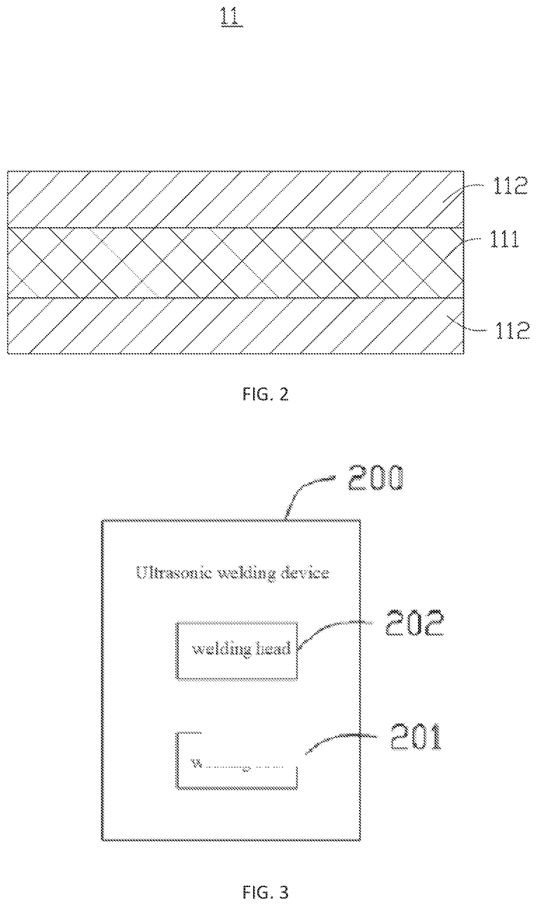

Referring to FIG. 2, the negative electrode piece 11 comprises a negative electrode current collector 111 and a negative electrode active layer 112 provided on the negative electrode current collector 111. In this embodiment, the negative electrode active layer 112 includes a silicon negative electrode material. The silicon negative electrode material includes at least one of silicon element, silicon compound and silicon alloy. Among them, the single-sided coating mass of the silicon negative electrode material on the negative electrode current collector 111 is 10 g/m2 to 85 g/m2.

The battery 100 further comprises a tab 20. The tab 20 is welded to the negative electrode current collector 111. Among them, a horizontal tensile machine is used to test the welding strength of the tab 20. The horizontal tensile machine has a tensile rate of 1 mm/s. The welding strength a of the tab 20 in the initial battery 100 is 18.7 N/m to 41.6 N/m.

in this embodiment, the capacity per gram C of the silicon negative electrode material, the welding strength a of the tab 20 in the initial battery 100 and the welding strength b of the tab 20 in the battery 100 after 300 cycles have the following relationship:

$$when 400 mAh / g < C \leq 600 mAh / g , 50 \% < b / a < 65 \% ; \\ when 600 mAh / g < C \leq 800 mAh / g , 65 \% < b / a < 80 \% ; \\ when 800 mAh / g < C \leq 1000 mAh / g , 80 \% < b / a < 90 \% ; and \\ when C > 1000 mAh / g , T \times f = b / a > 90 \% .$$

As such, the relationship between the capacity per gram C of the silicon negative electrode material and the welding strength ratio b/a of the tab 20 in the battery 100 after 300 cycles is defined to effectively avoid the problem of de-soldering of the tab 20 caused by the wrinkle and deformation of the negative electrode piece 11 due to the expansion and contraction of the silicon negative electrode material during the charging and discharging process of the battery 100, thereby ensuring the normal transmission of electrons in the battery 100 during the charging and discharging process.

Among them, at 25° C., the battery 100 is charged to 4.45 V with a constant current of 0.5 C and stands still for 2 minutes; and then the battery 100 is discharged to 3.0 V with a constant current of 0.5 C and stands still for 2 minutes, and take this as 1 cycle. The initial battery 100 is an uncycled battery.

In this embodiment, the tab 20 is welded to the negative electrode current collector 111 by an ultrasonic welding device 200. Among them, the ultrasonic welding device 200 comprises a welding seat 201 and a welding head 202. The welding seat 201 plays the role of fixing and supporting the workpiece during ultrasonic welding, and the welding head 202 is in contact with the workpiece during ultrasonic welding, and is used to transmit ultrasonic vibration energy to the workpiece.

Specifically, the tab 20 and the negative electrode piece 11 are stacked and fixed on the welding seat 201; and then the welding head 202 is used to pressurize the stacked tabs 20 and the negative electrode pieces 11 to transmit ultrasonic vibration energy to the tab 20 and the negative electrode piece 11, so that the tab 20 and the negative electrode piece 11 rub against each other and fuse, thereby the tab 20 being welded to the negative electrode current collector 111. In this embodiment, the welding seat 201 and the welding head 202 need to be heated before welding. Among them, the heating method of the welding seat 201 and the welding head 202 is not limited to resistance heating, induction heating or laser heating. In one embodiment, the welding seat 201 and the welding head 202 need to be heated simultaneously before welding,

Wherein the temperature of the welding head 202, the vibration frequency f of the welding head 202 and the capacity per gram C of the silicon negative electrode material have the following relationship:

$$when 400 mAh / g < C \leq 600 mAh / g , T \times f = 2 \sim 5.5 \times C ; \\ when 600 mAh / g < C \leq 800 mAh / g , T \times f = 6 \sim 10.8 \times C ; \\ when 800 mAh / g < C \leq 1000 mAh / g , T \times f = 11.5 \sim 14.5 \times C ; \\ When C > 1000 mAh / g , T \times f = 15 \sim 20.8 \times C .$$

In this way, the relationship between the capacity per gram C of the silicon negative electrode material and the temperature T and the vibration frequency f of the welding head 202 is defined to select the corresponding temperature and vibration frequency f of the welding head 202. under different capacities per gram C of the silicon negative electrode material, so that the tab 20 and the negative electrode piece 11 are welded to ensure the welding strength between the tab 20 and the negative electrode current collector 111.

In some embodiments, the temperature T of the welding head 202, the vibration frequency f of the welding head 202 and the capacity per gram C of the silicon negative electrode material have the following relationship:

$$when 400 mAh / g < C \leq 600 mAh / g , T \times f = 3.3 \sim 5 \times C ; \\ when 600 mAh / g < C \leq 800 mAh / g , T \times f = 6.5 \sim 10 \times C ; \\ when 800 mAh / g < C \leq 1000 mAh / g , T \times f = 12 \sim 14 \times C ; \\ when C > 1000 mAh / g , T \times f = 15.5 \sim 18 \times C .$$

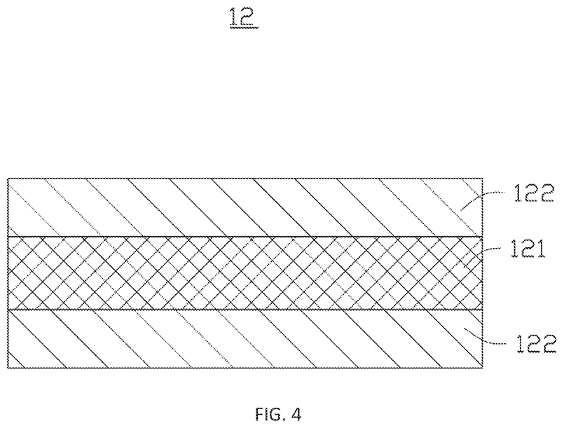

Referring to FIGS. 1 and 4, the positive electrode piece 12 comprises a positive electrode current collector 121 and a positive electrode active layer 122 provided on the positive electrode current collector 121. A tab 20 is welded on the positive electrode current collector 121. In one embodiment, the positive active layer 122 comprises lithium cobaltate.

Further, referring to FIG. 1, the battery 100 further comprises a housing 30. The winding unit 10 is accommodated in the housing 30.

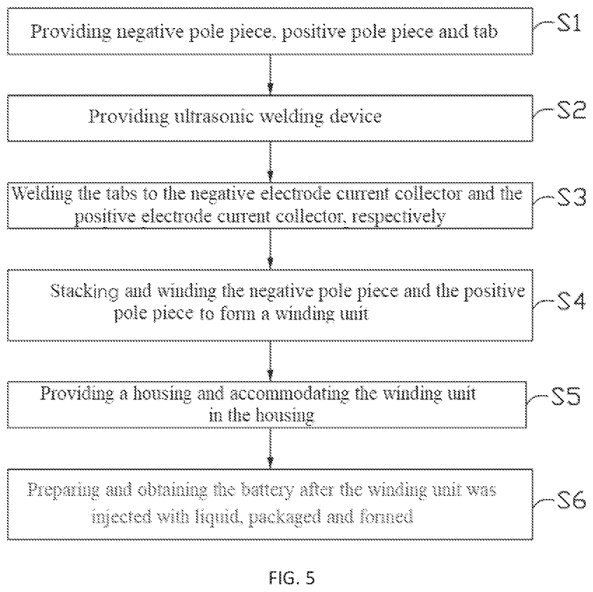

Referring to FIG. 5, the present application also provides a method for preparing a battery 100, comprising the following steps:

Step S1, providing the negative electrode piece 11, the positive electrode piece 12 and the tab 20 described above.

Step S2, providing the ultrasonic welding device 200 described above.

Step S3, the tabs 20 are welded to the negative electrode current collector 111 and the positive electrode current collector 121, respectively.

Specifically, first, the tabs 20 and the negative electrode pieces 11 are stacked and fixed on the welding seat 201. Next, the welding head 202 is used to pressurize the stacked tabs 20 and the negative electrode pieces 11 to transmit ultrasonic vibration energy to the tabs 20 and the negative electrode pieces 11, so that the tabs 20 and the negative electrode piece 11 nib against each other and fuse to weld the tab 20 to the negative electrode current collector 111.

Thereafter, the tabs 20 and the positive electrode pieces 12 are stacked and fixed on the welding seat 201, and then the welding head 202 is used to pressurize the stacked tabs 20 and the positive electrode pieces 12 to transmit ultrasonic vibration energy to the tab 20 and the positive electrode piece 12, so that the tab 20 and the positive electrode piece 12 rub against each other and fuse to weld the tab 20 to the positive electrode current collector 121.

Step S4, the negative electrode piece 11 and the positive electrode piece 12 are stacked and wound to form a winding unit 10.

Step S5, providing the above-mentioned housing 30 and accommodating the winding unit 10 in the housing 30.

Step S6, injecting the winding unit 10 with liquid, packaging, and forming to prepare the battery 100.

Wherein the sequence of individual steps in steps S1-S6 can be adaptively adjusted according to the actual situation.

The present application will be specifically described below through examples and comparative examples.

### Comparative Example 1

Preparation of the negative electrode piece 11: a copper foil with a thickness of 10 was used as the negative electrode current collector 111, and the negative electrode active slurry containing silicon negative electrode material was uniformly coated on both surfaces of the negative electrode current collector 111 to form the negative electrode active layer 112. Next, after drying and cold pressing, the negative electrode piece 11 was prepared. Among them, the single-sided coating mass of the silicon negative electrode material on the negative electrode current collector 111 was 10 g/m2 to 85 g/m2. In Comparative Example 1, the capacity per gram C of the silicon negative electrode material in the negative electrode active layer 112 was 405

Preparation of the positive electrode piece 12: an aluminum foil with a thickness of 9 μm was used as the positive electrode current collector 121, and the positive electrode active slurry containing lithium cobaltate was uniformly coated on both surfaces of the positive electrode current collector 121 to form the positive electrode active layer 122. Next, after drying and cold pressing, the positive electrode piece 12 was prepared.

Welding of the tabs 20: the tabs 20 were welded to the negative electrode current collector 111 and the positive electrode current collector 121 respectively by using the ultrasonic welding device 200. In Comparative Example 1, the tab 20 and the negative electrode current collector 111 as well as the tab 20 and the positive electrode current collector 121 were subjected to ultrasonic welding by using the ultrasonic welding device 200 by welding mean in which the welding seat 201 was heated at 300° C. and the welding head 202 was not heated. Among them, the vibration frequency f of the welding head 202 was 20 kHz, and the welding pressure was 25 kg. The width of the tab 20 was 8 mm and the thickness was 100 μm.

Preparation of the battery: The negative electrode piece 11 and the positive electrode piece 12 plus the separator 13 were made into an 11-layer winding unit by winding. The winding unit was injected with liquid, packaged, and formed into a battery. Among them, the length of the battery was 96 mm, the width thereof was 39 mm, and the thickness thereof was 33 mm.

Among them, the welding strength of the tabs 20 welded to the negative electrode current collector 111 in the initial battery 100 was tested by using a horizontal tensile machine. The tensile rate of the horizontal tensile machine was 1 mm/s. Among them, in the initial battery 100, the welding strength a of the tab 20 welded on the negative electrode current collector 111 was 14.5 N/m. In the battery 100 after 300 cycles, the welding strength of the tab 20 welded to the negative electrode current collector 111 was b. The welding strength ratio b/a of the tabs 20 in the battery 100 after 300 cycles was less than 50%.

In Comparative Example 1, the welding places of the tabs 20 in the battery 100 after 300 cycles had a de-soldering phenomenon. Among them, the tab 20 in the battery 100 after 300 cycles was compared with the tab 20 in the initial battery 100. If any solder joint on the tab 20 fell off, it was determined that there was de-soldering in the tab 20.

### Comparative Example 2

Comparative Example 2 differed from Comparative Example 1 in the capacity per gram C of the silicon negative electrode material in the negative electrode active layer 112. In Comparative Example 2, the capacity per gram C of the silicon negative electrode material in the negative electrode active layer 112 was 580 mAh/g.

Compared with Comparative Example 1, in Comparative Example 2, the welding strength of the tabs 20 in the initial battery 100 and the welding strength ratio b/a of the tabs 20 in the battery 100 after 300 cycles did not change.

In Comparative Example 2, the welding places of the tabs 20 in the battery 100 after 300 cycles had a de-soldering phenomenon,

### Comparative Example 3

Comparative Example 3 differed from Comparative Example 1 in the capacity per gram C of the silicon negative electrode material in the negative electrode active layer 112 and the vibration frequency f of the welding head 202. In Comparative Example 3, the capacity per gram C of the silicon negative electrode material in the negative electrode active layer 112 was 790 mAh/g, and the vibration frequency f of the welding head 202 was 30 kHz.

In Comparative Example 3, the welding strength a of the tabs 20 in the initial battery 100 was 20.3 N/m. The welding strength ratio b/a of the tabs 20 in the battery 100 after 300 cycles was: 50%<b/a<65%.

In Comparative Example 3, the welding places of the tabs 20 in the battery 100 after 300 cycles had a de-soldering phenomenon.

### Comparative Example 4

Comparative Example 4 differed from Comparative Example 1 in the capacity per gram C of the silicon negative electrode material in the negative electrode active layer 112 and the vibration frequency f of the welding head 202. In Comparative Example 4, the capacity per grain C of the silicon negative electrode material in the negative electrode active layer 112 was 990 mAh/g, and the vibration frequency f of the welding head 202 was 40 kHz.

In Comparative Example 4, the welding strength a of the tabs 20 in the initial battery 100 was 28.7 N/m. The welding strength ratio b/a of the tabs 20 in the battery 100 after 300 cycles was: 65%<b/a<80%.

In Comparative Example 4, the welding places of the tabs 20 in the battery 100 after 300 cycles had a de-soldering phenomenon.

### Comparative Example 5

Comparative Example 5 differed from Comparative Example 1 in the capacity per grain C of the silicon negative electrode material in the negative electrode active layer 112 and the vibration frequency f of the welding head 202. In Comparative Example 5, the capacity per gram C of the silicon negative electrode material in the negative electrode active layer 112 was 1100 mAh/g, and the vibration frequency f of the welding head 202 was 50 kHz.

In Comparative Example 5, the welding strength a of the tabs in the initial battery was 32.2 N/m. The welding strength ratio b/a of the tabs 20 in the battery 100 after 300 cycles was: 80%<b/a<90%.

In Comparative Example 5, the welding places of the tabs 20 in the battery 100 after 300 cycles had a de-soldering phenomenon.

### Example 1

Example 1 differed from Comparative Example 1 in that the tab 20 and the negative electrode current collector 111 were performed ultrasonic welding by using the ultrasonic welding device 200 and the welding method in which the welding head 202 and the welding seat 201 were heated in Example 1. Among them, the temperature T of the welding head, the vibration frequency f of the welding head and the capacity per gram C of the silicon negative electrode material had the following relationship: when 400 mAh/g<C≤600 mAh/g, T×f=2˜5.5×C.

The heating temperature of the welding head 202 was selected to be 100° C.

In Example 1, the welding strength a of the tabs 20 in the initial battery 100 was 18.7 N/m. The welding strength ratio b/a of the tabs 20 in the battery 100 after 300 cycles was: 50%<b/a<65%.

Compared with Comparative Example 1, the welding places of the tabs 20 in the battery 100 after 300 cycles had no de-soldering phenomenon in Example 1.

### Example 2

Example 2 differed from Comparative Example 2 in that the tab 20 and the negative electrode current collector 111 were performed ultrasonic welding by using the ultrasonic welding device 200 and the welding method in which the welding head 202 and the welding seat 201 were heated in Example 2. Among them, the temperature T of the welding head, the vibration frequency f of the welding head and the capacity per gram C of the silicon negative electrode material had the following relationship: when 400 mAh/g<C≤600 mAh/g, T×f=2˜5.5×C.

The heating temperature of the welding head 202 was selected to be 100° C.

In Example 2, the welding strength a of the tabs 20 in the initial battery 100 was 18.7 N/m. The welding strength ratio b/a of the tabs 20 in the battery 100 after 300 cycles was: 50%<b/a<65%.

Compared with Comparative Example 2, the welding places of the tabs 20 in the battery 100 after 300 cycles had no de-soldering phenomenon in Example 2.

### Example 3

Example 3 differed from Comparative Example 3 in that the tab 20 and the negative electrode current collector 111 were performed ultrasonic welding by using the ultrasonic welding device 200 and the welding method in which the welding head 202 and the welding seat 201 were heated in Example 3. Among them, the temperature T of the welding head, the vibration frequency f of the welding head and the capacity per gram C of the silicon negative electrode material had the following relationship: when 600 mAh/g<C≤800 mAh/g, T×f=6˜10.8×C.

The heating temperature of the welding head 202 was selected to be 200° C.

In Example 3, the welding strength a of the tabs 20 in the initial battery 100 was 29.4 N/m. The welding strength ratio b/a of the tabs 20 in the battery 100 after 300 cycles was: 60%<b/a<80%.

Compared with Comparative Example 3, the welding places of the tabs 20 in the battery 100 after 300 cycles had no de-soldering phenomenon in Example 3.

### Example 4

Example 4 differed from Comparative Example 4 in that the tab 20 and the negative electrode current collector 111 were performed ultrasonic welding by using the ultrasonic welding device 200 and the welding method in which the welding head 202 and the welding seat 201 were heated in Example 4. Among them, the temperature T of the welding head, the vibration frequency f of the welding head and the capacity per gram C of the silicon negative electrode material had the following relationship: when 800 mAh/g<C≤1000 mAh/g, T×f=11.5˜14.5×C.

The heating temperature of the welding head 202 was selected to be 300° C.

In Example 4, the welding strength a of the tabs 20 in the initial battery 100 was 35.8 N/m. The welding strength ratio b/a of the tabs 20 in the battery 100 after 300 cycles was: 80%<b/a<90%.

Compared with Comparative Example 4, the welding places of the tabs 20 in the battery 100 after 300 cycles had no de-soldering phenomenon in Example 4.

### Example 5

Example 5 differed from Comparative Example 5 in that the tab 20 and the negative electrode current collector 111 were performed ultrasonic welding by using the ultrasonic welding device 200 and the welding method in which the welding head 202 and the welding seat 201 were heated in Example 5. Among them, the temperature T of the welding head, the vibration frequency f of the welding head and the capacity per gram C of the silicon negative electrode material had the following relationship: when C<1000 mAh/g, T×f=15˜8×C.

The heating temperature of the welding head 202 was selected to be 350° C.

In Example 5, the welding strength a of the tabs 20 in the initial battery 100 was 41.6 N/m. The welding strength ratio b/a of the tabs 20 in the battery 100 after 300 cycles was: b/a>90%.

Compared with Comparative Example 5, the weldingplaces of the tabs 20 in the battery 100 after 300 cycles had no de-soldering phenomenon.

TABLE 1

| | Capacity per | | | Whether the welding | | |
|---|---|---|---|---|---|---|
| | gram C of the | Healing | Vibration | places of the tabs in | | |
| | silicon anode | temperature T | frequency f of | the battery after 300 | Weld | |
| | material | of the welding | the welding | cycles had de-soldered | strength a | |
| | (mAh/g) | head (° C.) | head (kHz) | phenomenon | (N/m) | b/a |
| Com. Ex. 1 | 405 | No heating | 20 | Yes | 14.5 | <50% |
| Com. Ex. 2 | 580 | No heating | 20 | Yes | 14.5 | <50% |
| Com. Ex. 3 | 790 | No heating | 30 | Yes | 20.3 | 50% < a/b < 65% |
| Com. Ex. 4 | 990 | No heating | 40 | Yes | 28.7 | 65% < a/b < 80% |
| Com. Ex. 5 | 1100 | No heating | 50 | Yes | 32.2 | 80% < a/b < 90% |
| Ex. 1 | 405 | 100 | 20 | No | 18.7 | 50% < a/b < 65% |
| Ex. 2 | 580 | 100 | 20 | No | 18.7 | 50% < a/b < 65% |
| Ex. 3 | 790 | 200 | 30 | No | 29.4 | 65% < a/b < 80% |
| Ex. 4 | 990 | 300 | 40 | No | 35.8 | 80% < a/b < 90% |
| Ex. 5 | 1100 | 350 | 50 | No | 41.6 | >90% |

Among them, Table 1 showed the preparation conditions of Comparative Examples 1-5 and Examples 1-5 and the corresponding test results.

As can be seen from Table 1, by comparing Example 1 and Comparative Example 1, Example 2 and Comparative Example 2, Example 3 and Comparative Example 3, Example 4 and Comparative Example 4, and Example 5 and Comparative Example 5, under the condition that the capacity per gram C of the silicon negative electrode material was constant, the welding strength a of the tab 20 in the initial battery 100 and the welding strength ratio b/a of the tabs 20 in the battery 100 after 300 cycles were raised by using the ultrasonic welding device 200 and the method in which the welding seat 201 and the welding head 202 were heated. In addition, by comparing Example 1 and Comparative Example 3, Example 2 and Comparative Example 3, Example 3 and Comparative Example 4, and Example 4 and Comparative Example 5, it can be seen that the relationship between the capacity per gram C of the silicon negative electrode material and the welding strength ratio b/a of the tabs 20 in the battery 100 after 300 cycles was defined to enable to effectively avoid the problem of de-soldering of the tabs 20 caused by the wrinkling and deformation of the negative electrode piece 11 due to the expansion and contraction of the silicon negative electrode material during the charging and discharging process of the battery 100, thereby ensuring the normal transmission of electrons during the charging and discharging process of the battery 100. In addition, according to Examples 1 to 5, it can be seen that with the continuous increase in the capacity per gram C of the silicon negative electrode material, the temperature T of the welding head 202, the vibration frequency f of the welding head 202 and the capacity per gram C of the silicon negative electrode material had the following relationship:

$$when 400 mAh / g < C \leq 600 mAh / g , T \times f = 2 \sim 5.5 \times C ; \\ when 600 mAh / g < C \leq 800 mAh / g , T \times f = 6 \sim 10.8 \times C ; \\ when 800 mAh / g < C \leq 1000 mAh / g , T \times f = 11.5 \sim 14.5 \times C ; \\ When C > 1000 mAh / g , T \times f = 15 \sim 20.8 \times C .$$

The heating temperature T and vibration frequency f for the welding head 202 could be selected to raise the welding strength a of the tabs 20 in the initial battery 100 and the welding strength ratio b/a of the tabs 20 in the battery 100 after 300 cycles. In addition, by comparing Example 1 and Example 2, it can be seen that under the premise that the temperature T and vibration frequency f of the welding head 202 were constant, the increase of the capacity per grain C of the silicon negative electrode material within a certain range would not change the welding strength a of the tab 20 in the initial battery 100 and the welding strength ratio b/a of the tab 20 in the battery 100 after 300 cycles.

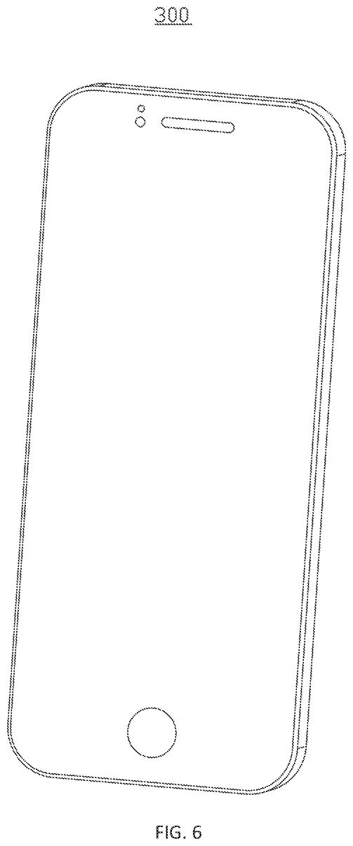

Referring to FIG. 6, the present application further provides an electrical device 300. The electrical device 300 comprises the battery 100 described above. Among them, the electrical device 300 may be a mobile electronic device, an energy storage device, an electric vehicle, a hybrid electric vehicle, and the like. The mobile electronic device may be a mobile phone, a wearable electronic device, a tablet computer, a notebook computer, and the like.

The above-mentioned embodiments are only used to illustrate the technical solutions of the present application and not to limit thereto. Although the present application has been described in detail with reference to the preferred embodiments, those skilled in the art should understand that the technical solutions of the present application can performed modification or equivalent substitution without departing from the spirit and essence of the technical solutions of the present application.

What is claimed is:

1. A battery, comprising: a winding unit formed by winding a negative electrode piece and a positive electrode piece together, wherein the negative electrode piece comprises a negative electrode current collector and a negative electrode active layer provided on the negative electrode current collector, the negative electrode active layer comprises a silicon negative electrode material; and the battery further comprises:
a tab welded to the negative electrode current collector;
wherein,
$$when 400 mAh / g < C \leq 600 mAh / g , 50 \% < b / a < 65 \% ; \\ when 600 mAh / g < C \leq 800 mAh / g , 65 \% < b / a < 80 \% ; \\ when 800 mAh / g < C \leq 1000 mAh / g , 80 \% < b / a < 90 \% ; and \\ when C > 1000 mAh / g , T \times f = b / a > 90 \% ;$$
C is a capacity per gram of the silicon negative electrode material, a is a welding strength of the tab in the battery at an initial stage and b is a welding strength of the tab in the battery after 300 cycles.

2. The battery of claim 1, wherein the silicon negative electrode material comprises at least one selected from the group consisting of silicon element, silicon compound, and silicon alloy.

3. The battery of claim 1, wherein the welding strength of the tab is tested by using a horizontal tensile machine, and the horizontal tensile machine has a tensile rate of 1 mm/s.

4. The battery of claim 3, welding strength of the tab in the battery at the initial stage is 18.7 N/m to 41.6 N/m.

5. The battery of claim 1, wherein the tabs are welded to the negative electrode current collector by an ultrasonic welding device, and the ultrasonic welding device comprises a welding seat and a welding head, wherein the welding head and the welding seat need to be heated before welding.

6. The battery of claim 5, wherein a single-sided coating mass of the silicon negative electrode material on the negative electrode current collector is 10 g/m² to 85 g/m².

7. The battery of claim 6, wherein, when 400 mAh/g<C≤600 mAh/g, T×f=2 to 5.5×C; T is the temperature of the welding head, f is a vibration frequency of the welding head and C is the capacity per gram of the silicon negative electrode material.

8. The battery of claim 6, wherein when 600 mAh/g<C≤800 mAh/g, T×f=6 to 10.8×C; T is the temperature of the welding head, f is the vibration frequency of the welding head and C is the capacity per gram of the silicon negative electrode material.

9. The battery of claim 6, wherein when 800 mAh/g<C≤1000 mAh/g, T×f=11.5˜14.5×C; T is the temperature of the welding head, f is the vibration frequency of the welding head and C is the capacity per gram of the silicon negative electrode material.

10. The battery of claim 6, wherein when C>1000 mAh/g, T×f=15˜20.8×C; T is the temperature of the welding head, f is the vibration frequency of the welding head and C is the capacity per gram of the silicon negative electrode material.

11. An electrical device comprising a battery, wherein the battery comprises:
a winding unit formed by winding a negative electrode piece and a positive electrode piece together, wherein the negative electrode piece comprises a negative electrode current collector and a negative electrode active layer provided on the negative electrode current collector, the negative electrode active layer comprises silicon negative electrode material, and the battery further comprises:
a tab that is welded to the negative electrode current collector, wherein the capacity per gram C of the silicon negative electrode material, the welding strength a of the tab in the initial battery and the welding strength b of the tab in the battery after 300 cycles have the following relationship:
$$when 400 mAh / g < C \leq 600 mAh / g , 50 \% < b / a < 65 \% ; \\ when 600 mAh / g < C \leq 800 mAh / g , 65 \% < b / a < 80 \% ; \\ when 800 mAh / g < C \leq 1000 mAh / g , 80 \% < b / a < 90 \% ; and \\ when C > 1000 mAh / g , T \times f = b / a > 90 \% .$$

12. The electrical device of claim 11, wherein the silicon negative electrode material comprises at least one selected from the group consisting of silicon element, silicon compound, and silicon alloy.

13. The electrical device of claim 11, wherein the welding strength of the tab in the battery at the initial stage is 18.7 N/m to 41.6 N/m.

14. The electrical device of claim 11, wherein a single-sided coating mass of the silicon negative electrode material on the negative electrode current collector is 10 g/m to 85 g/m².

15. The electrical device of claim 11, wherein, when 400 mAh/g<C≤600 mAh/g, T×f=2 to 5.5×C; T is the temperature of the welding head, f is a vibration frequency of the welding head and C is the capacity per gram of the silicon negative electrode material.

16. The electrical device of claim 11, wherein when 600 mAh/g<C≤800 mAh/g, T×f=6 to 10.8×C; T is the temperature of the welding head, f is the vibration frequency of the welding head and C is the capacity per gram of the silicon negative electrode material.

17. The electrical device of claim 11, wherein when 800 mAh/g<C≤1000 mAh/g, T×f=11.5˜14.5×C; T is the temperature of the welding head, f is the vibration frequency of the welding head and C is the capacity per gram of the silicon negative electrode material.

18. The electrical device of claim 11, wherein when C>1000 mAh/g, T×f=15˜20.8×C; T is the temperature of the welding head, f is the vibration frequency of the welding head and C is the capacity per gram of the silicon negative electrode material.
